(19) United States
(12) Patent Application Publication
(10) Pub. No.: US 2018/0171557 A1
(43) Pub. Date: Jun. 21, 2018

(54) Support Plate for a Doctor of a Fiber Web Machine and Doctor Assembly of a Fiber Web Machine and Method in a Doctor of a Fiber Web Machine

(71) Applicant: Valmet Technologies Oy, Espoo (FI)

(72) Inventors: Atte Autio, Jyväskylä (FI); Tommi Luosma, Jyväskylä (FI); Hannu Eerikäinen, Varkaus (FI)

(73) Assignee: Valmet Technologies Oy, Espoo (FI)

(21) Appl. No.: 15/737,038

(22) PCT Filed: Jun. 14, 2016
(86) PCT No.: PCT/FI2016/050428

§ 371 Date: Dec. 15, 2017

(30) Foreign Application Priority Data
Jun. 17, 2015 (FI) 20155470
May 4, 2016 (FI) U20164104

(51) Int. Cl. D21G 9/00; D21G 3/00; G01L 1/24; G01L 1/00

(52) U.S. Cl. CPC D21G 9/0009; D21G 3/00; G01L 5/0076; G01L 1/005; G01L 1/246

(57) ABSTRACT

The invention relates to a support plate of a doctor in a fiber web machine. The support plate (10) is designed to be removably fitted to a blade holder (16) and to support a doctor (15) in the blade holder (16). The support plate (10) includes sensor devices (18) for detecting that a drop through has accrued either upstream from the doctor or at the doctor. The invention also relates to a doctor assembly of a fiber web machine and a method in a doctor of a fiber web machine.

The invention relates to a support plate for a doctor of a fiber web machine. The invention also relates to a doctor assembly of a fiber web machine and a method in a doctor of a fiber web machine.

Finnish patent application No. 20105682 discloses a support plate that is removably fitted in a doctor.

Many kinds of sensor devices have been proposed for doctor assemblies of a fiber web machine for monitoring the operation of a doctor assembly. For example, attempts have been made to determine the angle and linear pressure of a doctor blade, as well as a doctor drop-through. By adding sensor devices, position-specific information is also obtained more accurately. To achieve sufficient correspondence, known sensor devices are fitted in a doctor blade.

Doctor blades are often made of a hard material, to which the fastening of sensor devices is challenging. At the same time, for example, determination of linear pressure in a doctor blade is inaccurate. In addition, purchase costs of multifaceted sensor devices are high. The doctor blade being a consuming part, purchase costs of a doctor blade also become high. The situation is even worse with sensor devices that are securely fastened to a doctor blade, since their dismounting and remounting to a new doctor blade are practically impossible. In this case, new sensor devices must always be installed in a new doctor blade.

Correspondingly, Finnish patent No. 115237 discloses a doctor assembly for a fiber web machine equipped with sensor devices for monitoring the doctor assembly. Specifically, sensor devices are used to detect a doctor drop-through, which is rare, but when taking place, causes significant damage or at least a long production break. Various sensors located in different parts of the doctor assembly can be used for detection purposes. After detecting a drop-through, the necessary measures are carried out to eliminate the malfunction and to prevent further damage.

The reliability of detection has turned out to be a problem regardless of various sensors. False detections have also occurred leading to unnecessary production breaks. For example, optical and acoustic sensors function poorly in humid and noisy conditions. In practice, measurement information of such sensors also includes a lot of background noise, from which the impulse created by a drop-through is poorly discernible. In other words, the reliability of detecting a drop-through is low. A corresponding problem exists with mechanical sensors, which require a notable amount of material to be collected in the doctor assembly before detecting a drop-through. In addition, sensors placed in a doctor assembly gradually collect material on top of them, which may lead to a false alarm.

The object of the invention is to provide a novel support plate with new features for a doctor of a fiber web machine. The characteristic features of the support plate according to this invention are set forth in the appended claim 1. Another object of the invention is to provide a novel doctor assembly for a fiber web machine wherein new features can be configured faster and more reliably than before. The characteristic features of the doctor assembly according to this invention are set forth in the appended claim 13. A further object is to provide a new method for a doctor of a fiber web machine, which works well even in challenging operating environments. The characteristic features of the method according to this invention are set forth in the appended claim 16. In the invention, features can be configured by using certain types of sensor devices in a new and surprising way. By using a novel support plate, the configuration of features can be easily made a part of the doctor assembly. At the same time, consuming parts can be replaced regardless of sensor devices. A support plate equipped with sensor devices can also be temporarily fitted in the doctor assembly to solve problem situations, for example. In addition, drop-through detection can be implemented in the invention with simple elements and more accurately than heretofore. The support plate itself can vary, which enables its fitting in different doctor assemblies. Drop-through detection, for example, can be arranged in a doctor assembly in a simple way without additional structures. By applying the method, false alarms can be avoided and, on the other hand, it can be ensured that drop-through events, for example, are quickly detected thus preventing damage.

The invention is described below in detail by referring to the appended drawings that illustrate some of the embodiments of the invention, in which:

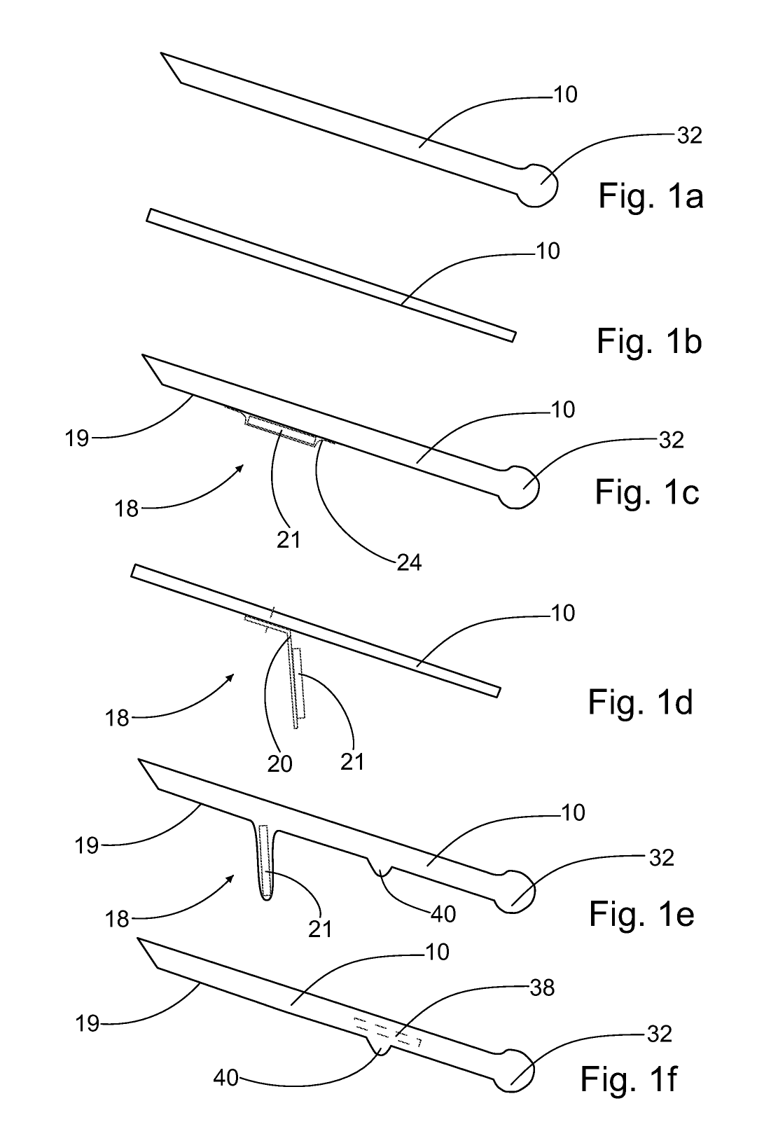

FIG. 1a shows a support plate according to prior art,

FIG. 1b shows another support plate according to prior art,

FIG. 1c shows a first embodiment of the support plate according to the invention,

FIG. 1d shows a second embodiment of the support plate according to the invention,

FIG. 1e shows a third embodiment of the support plate according to the invention,

FIG. 1f shows a fourth embodiment of the support plate according to the invention,

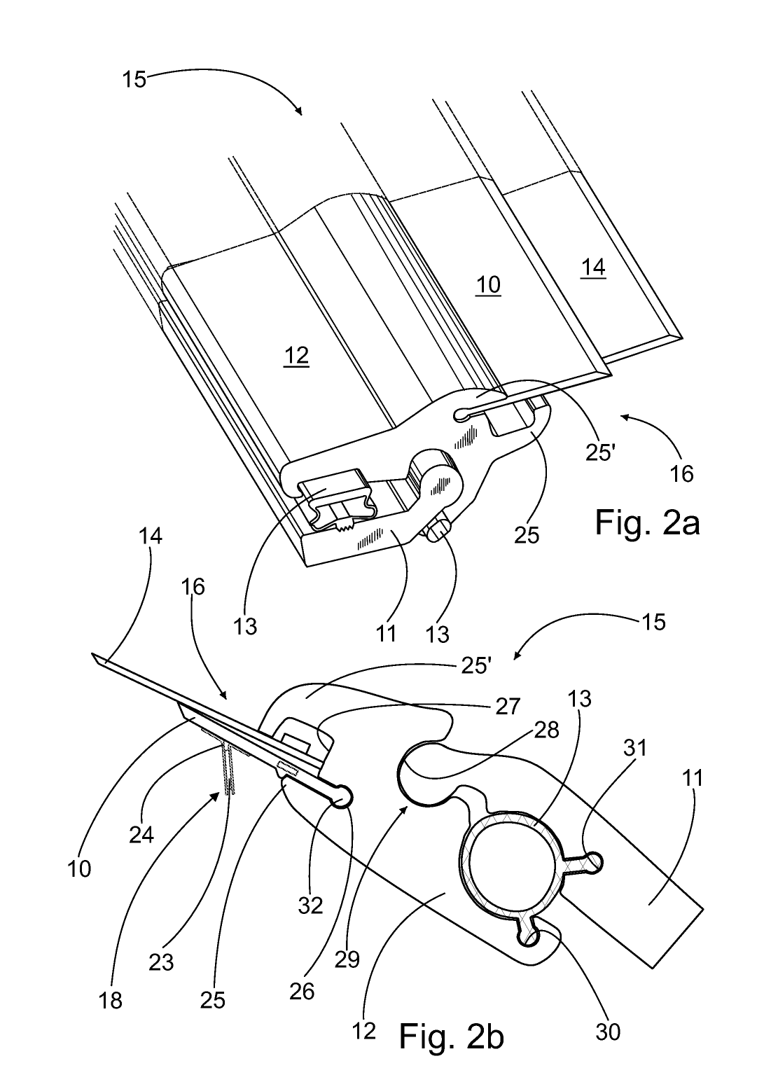

FIG. 2a shows a doctor assembly according to prior art equipped with a support plate,

FIG. 2b shows a doctor assembly equipped with a support plate according to the invention,

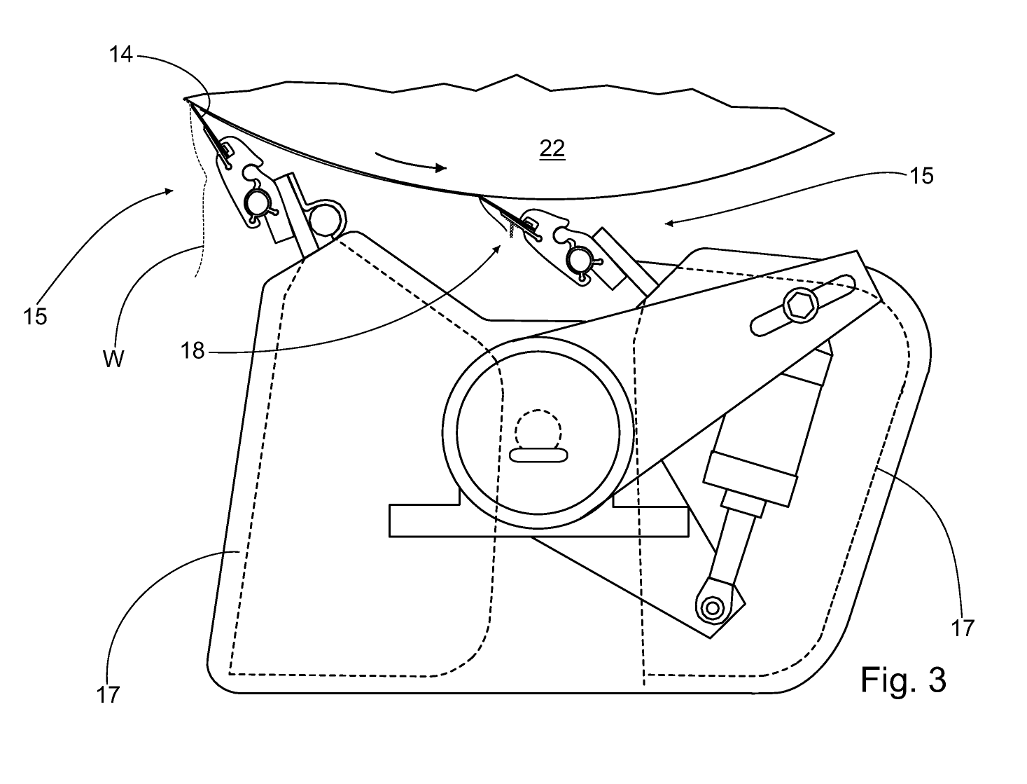

FIG. 3 shows a special embodiment of a doctor assembly according to the invention,

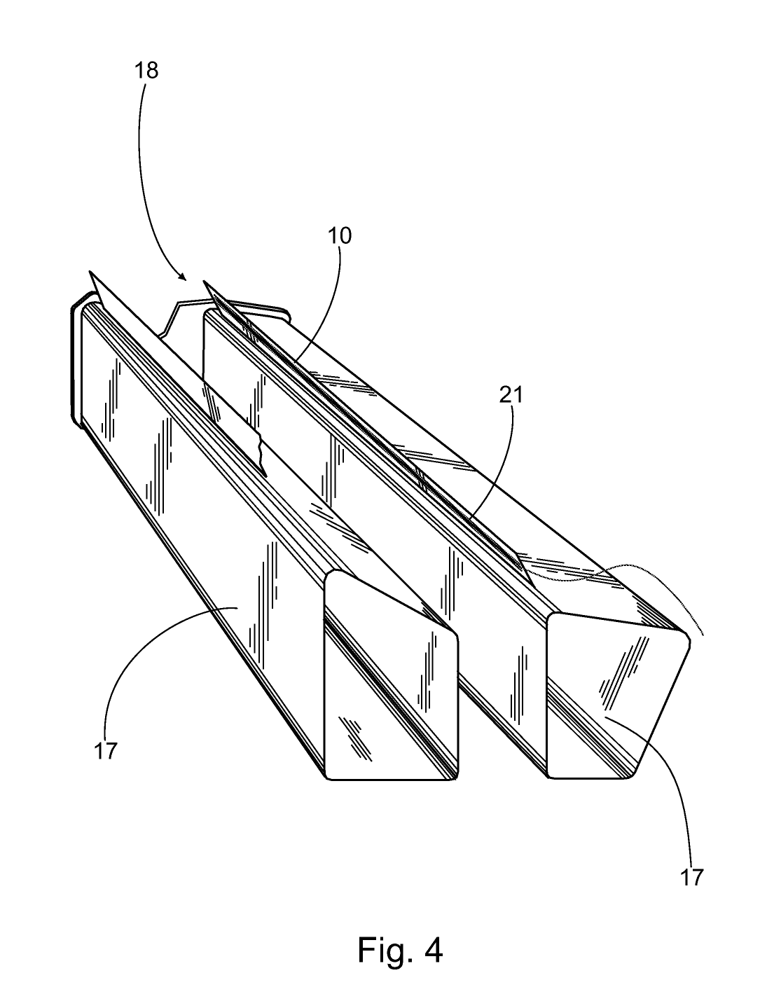

FIG. 4 is a basic drawing of a doctor assembly according to the invention,

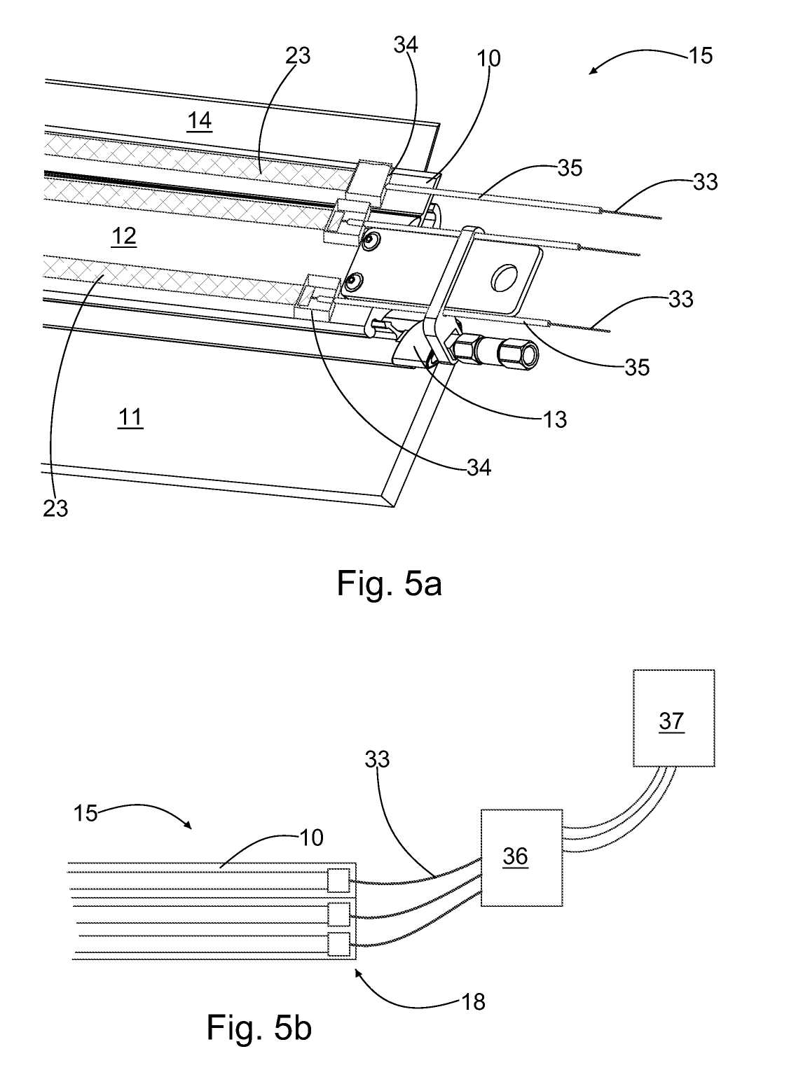

FIG. 5a shows a modification of a doctor assembly according to the invention,

FIG. 5b is a basic drawing of sensor devices according to the invention,

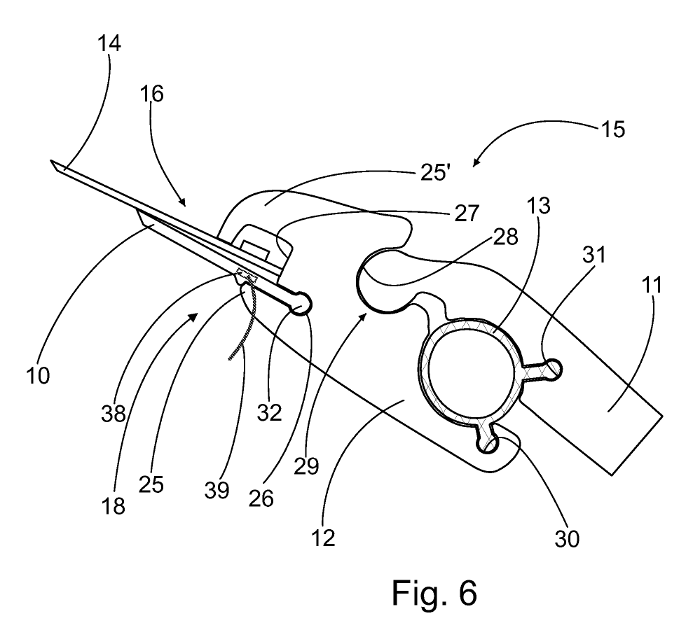

FIG. 6 shows another modification of a doctor assembly according to the invention,

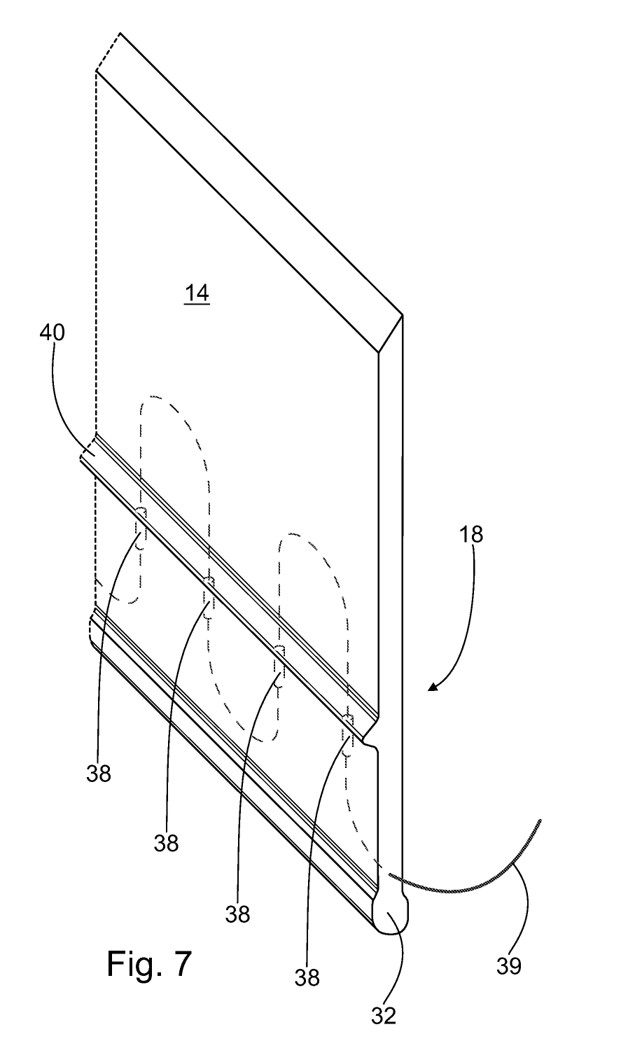

FIG. 7 shows the principle of a part of a support plate according to the invention,

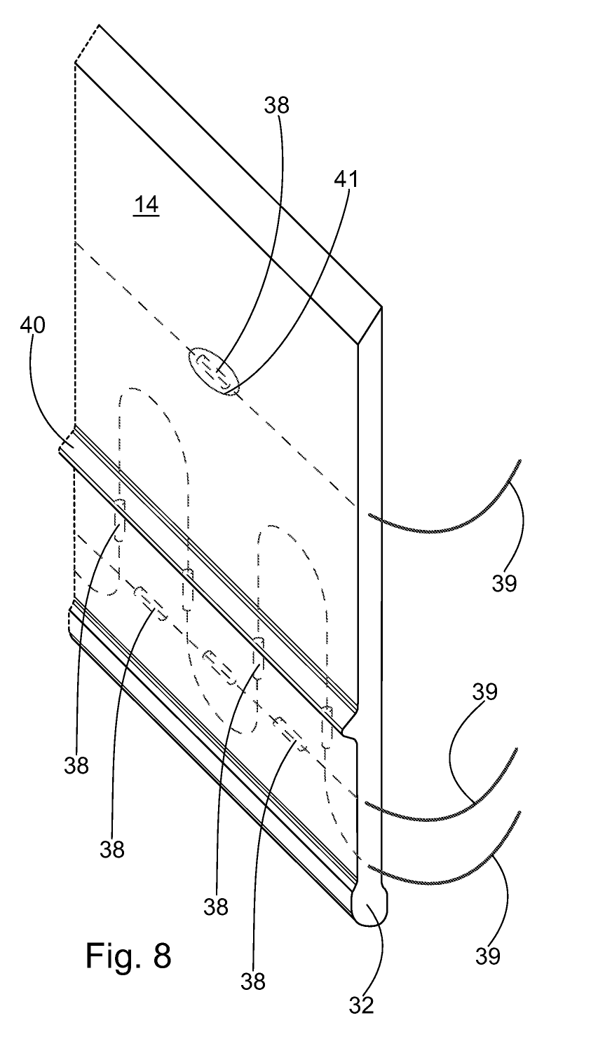

FIG. 8 shows a modification of a support plate according to the invention like in FIG. 7.

FIGS. 1a and 1b illustrate support plates according to prior art. The support plate 10 of FIG. 1b is a metal plate, whereas FIG. 1a shows a support plate made of a composite material, resembling a doctor blade. The support plate is used as part of a doctor assembly, which will be described in more detail later on. A doctor assembly is used particularly in fiber web machines, which include paper and board machines, as well as pulp making machines. The support plate is also called a front plate.

FIG. 2a illustrates a doctor assembly according to prior art. Today, the simplest configuration of a doctor assembly includes a doctor 15 with a frame component 11. The frame component is fastened to the frame of a fiber web machine, to a separate doctor beam or to another equipment connected to a fiber web machine. Correspondingly, the frame component 11 has a holder part 12 turnably fitted therein. More generally, the doctor 15 has a blade holder 16, in which a doctor blade 14 is fitted. The holder part 12 is turned relative to the frame component 11 using one or more loading hoses 13. Thus, the doctor blade 14 fitted in the holder part 12 can be pushed against the surface to be scraped and correspondingly, the doctor blade can be detached from the surface, for example, to replace the doctor blade. A support plate 10 is also fitted in the holder part 12 to transmit the support effect of the holder part 12 nearer to the tip of the doctor blade 14. The jaws 25 and 25′ of the holder part and the support plate 10 together form the blade holder 16. In practice, the doctor blade 14 is located in the gap between the longer jaw 25 and the support plate 10. In turn, the support plate 10 is located in the gap between the shorter jaw 25′ of the holder part 12 and the doctor blade 14. The frame component can also form an integral piece with the holder part. In this case, the doctor blade is loaded, for example, by turning the doctor beam, to which the blade holder is fastened. On the other hand, the blade holder can be fastened to the constructions of a fiber web machine, and a separate doctor beam 17 is often used (FIG. 3).

Thus, the invention relates to a support plate, specifically a support plate for a doctor of a fiber web machine. In other words, the support plate 10 is designed to be fitted in a doctor 15, more specifically, in a blade holder 16. The holder part 12 is equipped with at least a first slot 26 for the support plate 10 and a second slot 27 for the doctor blade 14 (FIG. 2b). In an advantageous embodiment, the holder part 12 is additionally equipped with a third slot 28 for the frame component 11. The third slot 28 together with the rounded end of the frame component 11 forms a joint 29 that allows the holder part 12 to turn relative to the frame component 11. The holder part 12 is additionally equipped with a fourth slot 30 for a loading hose 13. Likewise, the frame component 11 is then provided with a slot 31 for the loading hose 13. The support plate 10 supports the doctor blade 14 fitted in the holder part 12. The support plate 10 is placed removably in the slot 26 of the holder part 12. Advantageously, a bulge 32 is provided at the end of the support plate 10 to be fitted in the first slot 26 and the first slot 26 has a corresponding profile so that the support plate 10 will lock in place in the machine direction, i.e. in the depth direction of the support plate but can be extracted from the holder in its longitudinal direction, i.e. in the cross-machine direction, for service and/or replacement when necessary. During the operation, the doctor blade is loaded against the surface to be scraped, such as a roll surface.

A support plate 10 according to the invention includes sensor devices 18 for detecting a drop-through of a doctor 15 (FIGS. 1c-1e). With this surprising positioning, many advantages are achieved. Firstly, sensor devices can be located in a simple way near the position where a drop-through occurs. In practice, it is the contact of the doctor blade with the surface to be scraped that is imperfect during a drop-through allowing the fiber web to escape between the doctor blade and the surface to be scraped. Secondly, the doctor blade can be replaced while the sensor devices remain in the support plate. On the other hand, the support plate can also be replaced in which case sensor devices are simultaneously replaced. The rest of the doctor design can remain unchanged and completely free of sensor devices.

The support plate may be partly flexible to enable sensor devices to detect a doctor drop-through. In practice, the load between a doctor blade and a roll surface changes during a drop-through, which also affects the support plate that supports the doctor blade. For example, the support plate can experience a pressure shock and even bend, which can be detected with sensor devices. Advantageously, sensor devices 18 are fastened to the support plate 10 being partly detached from the surface 19 of the support plate 10. Thus, the support plate can be very rigid, and an actual drop-through is detected due to a deflection of sensor devices or another force subjected to it. Thus, deformations caused by doctor loading do not activate a drop-through alarm. Hence, certainty about a doctor drop-through can only be achieved when sensor devices are activated.

FIG. 1d shows a metal support plate 10 that is meant to be fastened to a metal blade holder (not shown). In practice, a metal support plate is fastened to a blade holder with bolts, for example. Here, the support plate has an angle strip 20 riveted thereto, on the rear side of which the sensor devices 18 are located. Sensor devices are protected behind the angle strip and below the support plate. Instead of an angle strip, it is possible to use a partly hanging pocket, within which sensor devices are located (not shown). Thus, sensor devices are protected in the pocket and are only activated when the pocket bends sufficiently. FIGS. 1c, 1e and 1f illustrate a support plate 10 made of fiber-reinforced composite plastic. In such a support plate, sensor devices can be easily fastened by gluing or taping, for example. Lamination can also be used, as in FIGS. 1e and 1f, where sensor devices 18 are fitted inside the base material of the support plate 10 during the manufacture of the support plate. Support plates 10 of FIGS. 1c, 1e and 1f can be used in the doctor 15 according to FIG. 2a, where the support plate 14 is form-lockable comprising notches and/or extensions 32 that snap tightly to the counter-surfaces of the holder part 12, i.e. to the first slot 26. The support plate can be withdrawn and, correspondingly, reinserted from the side of the doctor. Thus, the features of the doctor can be quickly changed and the support plate can be replaced, for example.

Advantageously, sensor devices 18 consist of one sensor element 21 extending essentially over the entire length of the support plate 10 (FIG. 4). Thus, the sensor assembly is simple and the sensor element can be easily glued or taped, for example, onto the surface of the support plate. Alternatively, the sensor element is first glued to the above-mentioned angle strip, which is then fastened to the support plate. The sensor element is activated when it or a construction supporting it bends sufficiently or is subjected to a sufficient force change. One advantageous sensor element is an electromechanical film sensor, one application of which is called EMFi (electromechanical film). A plastic film is thin and flexible and has constant electrical charge. In a sensor application, the film is compressed due to external forces and this generates a measurable change of charge due to the movement of electrodes. In other words, a clear electrical impulse is obtained through activation. Thus, an electromechanical sensor is concerned.

Another advantageous alternative for the sensor element is a piezo cable. Both alternatives are small and function even in demanding conditions. In addition, sensor elements can be located over the entire length of the support plate, which enables a detection of a drop-through over the entire distance of the doctor blade. As sensor elements are activated even by a small pressure change, sensor elements are sensitive. On the other hand, the fastening method of a sensor element can be used to tune sensor elements in the desired way to enable avoidance of false drop-through detections. In addition, said sensor elements have low operating voltage requirements and they are maintenance-free.

FIG. 3 is a lateral view of a doctor assembly of a fiber web machine according to the invention wherein a support plate 10 according to the invention is applied. An individual doctor 15 is illustrated in FIG. 2b. Advantageously, the doctor assembly is a double doctor wherein sensor elements 18 have been arranged at least in the latter one of the two doctors 15. In FIG. 3, the direction of rotation of the roll 22 to be scraped is shown with an arrow and the above-mentioned latter doctor is on the right-hand side. Thus, the drop-through of the first doctor can be detected. Sensor devices 18 can also be arranged in both doctors 15 of the double doctor. In this case, the sensor devices of the first doctor can detect malfunctions that may lead to a drop-through even in advance. Hence, the detection of a drop-through is more reliable when impulses of two pairs of sensor devices are available.

In the case of a double doctor, even a minor drop-through at the first doctor is detected when the fiber web hits the sensor devices arranged in the support plate of the second doctor. In normal use, only a few or no impulses are obtained from these sensor devices for the latter doctor. In other words, the background noise created by the sensor devices is nonexistent. Only after the fiber web hits the sensor devices of the support plate, a clearly detectable impulse is obtained, which is a reliable sign of a drop-through at the first doctor. In addition, it is sufficient that the fiber web contacts the sensor devices at some point. Thus, even a partial drop-through can be detected and the necessary actions can be carried out to remove the malfunction.

For example, to detect a drop-through of a doctor of a fiber web machine, sensor devices 18 are used in the method to detect a drop-through of a doctor 15. According to the invention, sensor devices 18 are fitted in a support plate 10 included in the doctor 15. As the support plate, a support plate according to the invention described above and equipped with sensor devices is used and this support plate is removably fitted in the doctor 15. In the case of malfunctions, the doctor assembly does not operate as planned. In particular, clogging of a double doctor when the first doctor drops through is a significant problem, which can now be avoided by using a new and surprising support plate.

In FIG. 3, a broken line illustrates the fiber web W that is to be released from the surface of the roll 22 with the first doctor, the fiber web is released and guided down to broke treatment. In other words, the fiber web itself hits the doctor blade 14 during a so-called run-down procedure. During production, the fiber web is already released before the first doctor blade. Then the doctor blade is used to keep the roll surface clean. A double doctor is used particularly in the press section of a fiber web machine. In addition to press rolls, other critical doctor assemblies are located in association with transfer belts and the first and last dryer cylinders.

During a drop-through, the contact of the doctor blade 14 with the surface of the roll 22 has failed and the fiber web can pass by the first doctor. In this situation, the blade pressure suddenly drops and the doctor blade may even bend, at least locally, applying a different pressure effect on the support plate of the first doctor. By this, the sensor devices of the support plate generate an electric impulse. Hence, necessary actions can be carried out. In the press section, for example, these actions may consist of lifting of the pick-up roll, relieving the nip load and opening the doctor. In this way, the malfunction can be removed as soon as possible without damage to the nearby structures. At the same time, the production break caused by the malfunction shortens. A quick reaction also avoids problems caused by a possible drop-through of the second doctor. When both doctors drop through, the fiber web coils up around the roll, which may lead to significant damage in the press section.

A so-called quick drop-through is described above where the doctor blade detaches from the roll surface and the fiber web coils up around the roll. The detachment of the doctor blade produces a clear impulse in sensor devices allowing reliable detection of a drop-through. By fitting sensor devices in the support plate of the latter doctor as well, another type of drop-through can also be detected. During a so-called slow drop-through, the fiber web can gradually advance below the first doctor blade to the second doctor blade collecting a bulk of stock between the doctors. Now, the fiber web hits the sensor devices in the support plate according to the invention located in the latter doctor, which enables detection of even a partial drop-through.

Sensor devices can be fitted to the support plate in several different ways. Generally, sensor devices are fitted on either side or on both sides of the support plate. For example, two EMFi films 23 are fastened to the support plate. One EMFi film 23 is glued to the rear side of the support plate 10 on the side of the doctor plate 14 (FIG. 2b). This film can detect a fast drop-through, which creates a sudden impulse in the support plate. On the other hand, the frequency and amplitude of impulses may change during operation, based on which it is possible to determine the doctor performance and in this way anticipate a possible drop-through. Correspondingly, the second EMFi film 23 is glued between teflon tapes 24 hanging down from the support plate 10. This second EMFi film can then detect a slow drop-through when the fiber web or its part hits the hanging tapes 24.

FIG. 5a illustrates sensor devices 18 that include three EMFi films 23. One of the films is fastened to the support plate 10 and two of them are fastened to the holder part 12. The doctor 15 of FIG. 5a can be arranged as the latter doctor in the position of FIG. 3. A cable 33 is provided at the end of the EMFi film 23 for leading a signal from the sensor devices 18 for further utilization. A fixing frame 34 provided in the connection point between the EMFi film 23 and the end of the cable 33 is fastened to the support plate 10 or the holder part 12. Finally, the fixing frame 34 is filled, for example, with epoxy to make the fastening and the joint resistant to hot, humid and often corroding conditions in the doctor position. In FIG. 5a, the fixing frame 34 fastened to the support plate 10 is filled with epoxy. Here, each cable 33 is additionally placed within a teflon hose 35 for protection. FIG. 5b shows a basic view of a doctor 15 and sensor devices 18 fitted in the doctor 15. From the doctor 15, the cables protected with teflon hoses 35 are led to a signal amplifier 36 and further to the machine control system 37. The signal amplifier is located at a distance of approximately two to three meters from the doctor, while the machine control system is further away in the machine hall or even in a remote location. Based on the signal arriving from the sensor devices, it is then possible to determine, for example, a doctor drop-through or properties of the doctor and/or the doctor environment.

A modification of a support plate 10 according to the invention includes Bragg gratings 38 as sensor elements 21 connected to a fiber-optic waveguide 39 for determining properties of a doctor 15 and/or the environment of a doctor 15. The support plate is thus adapted as a part of FBG measuring equipment (Fiber Bragg Grating). Since the property of a Bragg grating changes, for example, due to elongation, a load is also applied to the support plate when the doctor is loaded. Thus, a change in the grating can be indirectly used to determine, for example, the linear pressure applied by the doctor blade on the roll surface. In addition, Bragg gratings 38 are connected to a fiber-optic waveguide 39 (FIGS. 7 and 8). Thus, the data of all Bragg gratings connected to the same waveguide can be transmitted via one waveguide. Unlike the doctor blade, the support plate is not subject to wear during use. Thus, a support plate can be used for a long time, which means that the impact of the purchase cost of Bragg gratings and the waveguide on the total costs is reduced. A support plate according to the invention can also be used part-time to analyze the doctor assembly. In this case, a conventional support plate is replaced with a support plate equipped with Bragg gratings and properties of the doctor and/or the doctor environment are determined. After this, the necessary changes can be made and the original support plate can be remounted. Different sensor devices can be fitted in the same support plate, such as both a glued EMFi film and Bragg gratings.

In practice, a laser beam is transmitted to the waveguide and the data of each Bragg grating can be determined based on the light reflecting back. For example, the spectrum reflected by a Bragg grating changes due to an external force, which affects the propagation of light. Hence, the data of Bragg gratings can be individually determined. When the basic condition of a Bragg grating and the change behavior are known, the change can be determined by comparing the basic data with the changed data. For example, a wavelength change is proportional to elongation, which can be utilized for using a Bragg grating as a sensor.

As the support plate is partly flexible, Bragg gratings can be used to determine the deflection of the support plate and thereby indirectly the load applied to the doctor blade. In other words, the load between the doctor blade and the roll surface also affects the support plate that supports the doctor blade. When the position of Bragg gratings in the cross-direction of a fiber web machine is simultaneously known, the linear pressure profile of a doctor blade can be determined. Based on the linear pressure profile, it is possible to monitor, for example, the condition of a doctor blade and the general performance of a doctor assembly. Thus, for example, when a doctor blade wears down, the loading hose pressure can be changed to keep the linear pressure in a desired value. Too low a linear pressure lowers the scraping result. On the other hand, too high a linear pressure wears a doctor blade too quickly or damages the surface of the roll scraped. A local change in the linear pressure can also be an indication of a roughness change on the roll surface. Thus, based on this indication, maintenance measures can be commenced, such as roll surface grinding. A sudden change in the linear pressure can also be a sign of a doctor drop-through. In this case, a support plate can also be utilized as a break detector. On the other hand, recurring and periodic variation of linear pressure can result from roll vibrations, which can be caused by a bearing failure, for example. Hence, the linear pressure and changes can be utilized in a versatile manner.

In addition to elongation, the properties of a Bragg grating also change due to the temperature, humidity, acidity and vibrations. Therefore, the properties of a doctor environment can also be determined with a support plate according to the invention. For example, a steambox can be adjusted based on a temperature profile to achieve a desired moisture profile for the fiber web. On the other hand, a local temperature change can be a sign of a defect in a doctor blade or a roll. Doctor performance is also affected by lubrication showers. Thus, lubrication showers can be adjusted by monitoring the moisture profile. On the other hand, a local moisture deviation can indicate clogging of an individual nozzle. Furthermore, the amount of filler material to be supplied to the fiber web stock suspension can be adjusted based on acidity. The above-mentioned definitions are generally related to the center roll of a fiber web machine; however, a support plate can also be used in other positions. In surface sizing, for example, a uniform linear pressure is a requirement for an end product of uniform quality.

FIG. 1c shows a metal support plate 10 that is meant to be fastened, for example, to a metal blade holder (not shown). Here, a Bragg grating 38 used as sensor devices 18 is taped onto the surface 19 of the support plate 10. At the same time, the tape 24 fastens a waveguide, which is an optical fiber in practice (not shown). FIGS. 1c, 1e and 1f illustrate a support plate 10 made of fiber-reinforced composite plastic. In such a support plate, both Bragg gratings and a waveguide can be easily fastened by gluing or taping, for example. Lamination can also be used, as in FIG. 1f, where the Bragg gratings 38 are fitted inside the base material of a support plate 10 during the manufacture of the support plate. In other words, the Bragg gratings 38 and the fiber-optic waveguide 39 are inside the support plate 10 (FIGS. 7 and 8). Thus, the Bragg gratings and the waveguide are well protected and are kept securely in place.

Advantageously, the support plate 10 is an injection-laminated component. Thus, the Bragg gratings can be fastened to reinforced fibers to keep them precisely in desired positions. At the same time, the orientation of reinforced fibers can be set as desired in the support plate. In injection lamination, reinforced fibers are compressed in a mold by help of a film using a vacuum, which simultaneously aspirates the plastic matrix sprayed inside the film among reinforced fibers.

Support plates 10 of FIGS. 1e and 1f can be used in the doctor 15 according to FIGS. 2b and 6, where the support plate 14 is form-lockable comprising notches and/or extensions 32 that snap tightly to the counter-surfaces of the holder part 12, i.e. to the first slot 26. The support plate can be withdrawn and, correspondingly, reinserted from the side of the doctor. Thus, the properties of the doctor can be quickly changed and the support plate can be replaced, for example. Correspondingly, the doctor blade can be replaced while the Bragg gratings remain in the support plate. Equally, a support plate according to the invention is suitable for use in a doctor 15 according to FIG. 2a.

Advantageously, Bragg gratings 38 are located in association with a point of discontinuity 40 included in the support plate 10 (FIGS. 1f, 6, 7 and 8). In the embodiments disclosed, the point of discontinuity 40 is a bulge that is adaptable against the tip of the short jaw 25′ of the holder part. Thus, the position of the point of discontinuity remains unaltered and the support plate bends the most in this position. In this way, the correspondence of the support plate deformation with the doctor blade load remains as accurate as possible and the data obtained from Bragg gratings corresponds with the linear pressure as accurately as possible. Instead of a bulge, a reduction or other relief can be used, which locally increases the flexibility of the support plate. Thus, the deflection of the support plate is emphasized, which increases the change in Bragg gratings.

FIG. 7 shows a part of the support plate according to the invention. Here, Bragg gratings 38 have been placed within the base material to form an integral part with the support plate 10 during the manufacture. Each Bragg grating 38 is oriented in the depth direction of the support plate, that is, in the machine direction, in which case the deflection of the support plate 10 produces elongation in the longitudinal direction of the Bragg grating 38. Advantageously, Bragg gratings are located over the entire length of the support plate so that the linear pressure of a doctor blade, for example, can be detected over the entire width of a fiber web machine. Bragg gratings can also be located very near each other; however, the minimum radius of curvature of the waveguide can set limitations. Nevertheless, Bragg gratings set at distances of 150 mm in a 10,000 mm long support plate provide a very accurate linear pressure profile. At the end of the support plate, the waveguide 39 is exposed and can be connected to the FBG system's electronics. In long support plates, two waveguides fitted end to end can be used, of which both cover a half of the support plate length. By combining the data obtained from the waveguides, the linear pressure profile can be determined over the entire width of the fiber web machine.

The properties of the combination formed by Bragg gratings and a waveguide are precisely known after manufacture. After fitting the combination to the support plate, the properties of the whole entity are redefined. In other words, a support plate 10 according to the invention is calibrated together with Bragg gratings 38. In this way, the support plate can be installed in a doctor without changing or adjusting the doctor assembly itself. The support plate can be calibrated, for example, on a test equipment resembling a doctor assembly wherein the correspondence of the doctor blade load with the change of each Bragg grating can be determined. Thus, based on the data obtained from a calibrated support plate installed in a production machine, for example, the linear pressure profile can be accurately determined.

In FIG. 8, a total of three waveguides 39 are fitted in the support plate 10. The rear-most waveguide 39 is straight and the Bragg gratings 38 are set lengthwise to the support plate 10. These Bragg gratings can be used to determine vibrations and a doctor blade profile, for example. The front-most waveguide 39 has one Bragg grating 38 adapted to be partly visible through the opening 41. In this way, this Bragg grating 38 is protected but still in direct connection with the doctor environment. Hence, it is possible to monitor the temperature, moisture and acidity, for example.

A doctor assembly according to the invention complete with a support plate connected thereto contributes to the improvement of the utilization rate of a fiber web machine. By continuously monitoring the operation of a doctor assembly and the environment with an intelligent support plate, malfunctions can be assessed even in advance and a change in conditions is immediately detected. For example, detections can be used to determine the condition of a doctor blade, which facilitates the planning of maintenance shutdowns, for example. A support plate according to the invention can be easily applied in different doctor assemblies. In addition to a roll, the surface to be scraped can be a belt, such as a transfer belt or a fiber web in the case of surface sizing. Electronics connected to the support plate is easily combinable as part of the control of the fiber web machine, which enables versatile and uninterrupted doctor monitoring particularly in critical positions.

By detecting malfunctions and carrying out necessary measures, further damage is effectively avoided. As sensor devices can be used to continuously monitor the operation of a doctor assembly, malfunctions can be assessed even in advance. Particularly, the situation after the doctor blade is monitored, which enables the detection of several different malfunctions. Detections can be used to secondarily determine the condition of a doctor blade, which facilitates the planning of maintenance shutdowns, for example. A support plate and a method according to the invention can be easily applied in different doctor assemblies. In addition to a double doctor, all other doctors are possible, while the surface to be scraped is usually a roll or a belt, such as a transfer belt. Actions caused by a drop-through are easily combinable as a part of the control of a fiber web machine, which enables avoidance of further damage particularly in critical positions, at least when initial actions are automated. A method according to the invention can be easily applied in existing doctor assemblies particularly when using a support plate made of a composite material.

1-17. (canceled)

18. A doctor assembly for a fiber web machine comprising:
a holder;
a doctor blade mounted to extend in a cross-machine direction on the holder;
a support plate which is removably mounted to the holder in supporting engagement with the doctor blade;
wherein the support plate defines a cross machine length;
wherein the support plate having a doctor blade support side and an opposed side opposite the doctor blade support side, wherein the doctor blade support side has a distal end which supports a portion of the doctor blade which extends away from the holder;
at least one strain detection sensor mounted to extend in the cross-machine direction along the support plate and extending essentially over the entire length defined by the support plate.

19. The doctor assembly of claim 18 wherein the strain detection sensor includes Bragg gratings connected to a fiber-optic waveguide.

20. The doctor assembly of claim 18 wherein the strain detection sensor is an electromechanical sensor.

21. A doctor assembly for a fiber web machine comprising:
a holder;
a doctor blade mounted to the holder;
a support plate formed of a base material, and wherein the support plate is removably mounted to the holder;
wherein the support plate defines a cross machine length;
wherein the support plate having a doctor blade support side and an opposed side opposite the doctor blade support side, wherein the doctor blade support side has a distal end which supports a portion of the doctor blade which extends away from the holder;
at least one drop-through sensor which is mounted to the support plate opposed side and extends in a cross-machine direction along the support plate.

22. The doctor assembly according to claim 21 wherein at least one, of the at least one drop-through sensors is an electromechanical sensor.

23. The doctor assembly according to claim 21 wherein at least one, of the at least one drop-through sensors is a piezo cable.

24. The doctor assembly according to claim 21 wherein at least one, of the at least one drop-through sensors includes Bragg gratings connected to a fiber-optic waveguide.

25. The doctor assembly according to claim 21 further comprising a second holder mounted and spaced ahead of the holder;
a second doctor blade mounted to the second holder;
a second support plate which is removably mounted to the holder;
wherein the second support plate having a second doctor blade support side and wherein the second doctor blade support side has a second distal end which supports a portion of the second doctor blade which extends away from the second holder;
wherein the second doctor blade is positioned with respect to the doctor blade such that if a fiber web drops through the first doctor blade the at least one drop-through sensor will be hit by the fiber web.

26. The doctor assembly according to claim 21 wherein the at least one drop-through sensor has portions which are partly detached from the side opposite the doctor blade support side so as to extend below the side opposite the doctor blade support side.

27. The doctor assembly according to claim 21 wherein the support plate is rigid such that deformations caused by the doctor loading does not activate the at least one drop-through sensor, and a fiber web is only detected by a deflection of the at least one drop-through sensor.

28. The doctor assembly according to claim 21 wherein the support plate has an angle strip riveted thereto and the at least one drop-through sensor is located on a portion of the angle strip which extends away from the doctor blade and the support plate and faces the holder.

29. The doctor assembly according to claim 21 wherein the support plate has a partly hanging pocket, within which the at least one drop-through sensor is located such that at least one drop-through sensor only activates when the pocket is bent.

30. The doctor assembly according to claim 21 wherein the support plate is formed of fiber-reinforced composite plastic and the at least one drop-through sensor is fastened thereto by gluing or taping.

31. The doctor assembly according to claim 21 wherein the at least one drop-through sensor is fitted inside the base material of the support plate during the manufacture of the support plate.

32. The doctor assembly according to claim 21 wherein the support plate is form-lockable such that the support plate snaps tightly to a slot formed in the holder such that the support plate can be withdrawn and reinserted into the slot.

33. The doctor assembly according to claim 21 wherein the at least one drop-through sensor extends essentially over the entire length defined by the support plate.

34. The doctor assembly according to claim 21 further comprising a further drop-through sensor mounted to a side of the holder part which faces away from the doctor blade.

35. A doctor assembly for a fiber web machine comprising:
a holder part having jaws between which a doctor blade is mounted to extend in a cross-machine direction;
a support plate which is removably mounted to the holder in a first slot and retained therein by a bulge wherein the support plate extends in the cross-machine direction and between the jaws;
wherein the support plate defines a cross machine length;
wherein the support plate having a doctor blade support side and an opposed side opposite the doctor blade support side, wherein the doctor blade support side has a distal end which supports a portion of the doctor blade which extends away from the jaws and the holder;
a portion of the support plate forming a discontinuity opposite the doctor blade support side and protruding from the opposed side opposite the doctor blade, the discontinuity closely spaced from one of said jaws in a direction which extends from said one of the jaws toward the doctor blade support side distal end;
at least one strain detection sensor mounted to extend in the cross-machine direction along the support plate and to extend across the discontinuity.
wherein the strain detection sensor extends essentially over the entire length defined by the support plate.

36. The doctor assembly of claim 35 wherein the strain detection sensor includes Bragg gratings connected to a fiber-optic waveguide.

37. The doctor assembly of claim 35 wherein the strain detection sensor is an electromechanical sensor.
